(19) United States
(12) Patent Application Publication
(10) Pub. No.: US 2011/0199440 A1
(43) Pub. Date: Aug. 18, 2011

(54) LIQUID EJECTING APPARATUS

(75) Inventor: Masaru Kobashi, Matsumoto-shi (JP)

(73) Assignee: SEIKO EPSON CORPORATION, Shinjuku-ku (JP)

(21) Appl. No.: 13/027,880

(22) Filed: Feb. 15, 2011

(30) Foreign Application Priority Data
Feb. 15, 2010 (JP) 2010-029846

(51) Int. Cl. B41J 2/175

(52) U.S. Cl. 347/85

(57) ABSTRACT

A liquid ejecting apparatus includes, a plurality of liquid ejecting sections ejecting liquid, and a liquid supplying flow path. In the device, an upstream side of the liquid supplying flow path is coupled to the liquid supplying source while a downstream side of the liquid supplying flow path branches into a plurality of flow paths at a branch point and each of the plurality of flow paths is coupled to one of the liquid ejecting sections. In the liquid supplying flow path, an average flow path resistance value of a flow path upstream of the branch point serving as a reference is smaller than an average flow path resistance value of a flow path having the smallest average flow path resistance value among average flow path resistance values of flow paths downstream of the branch point serving as the reference.

### BACKGROUND

1. Technical Field

The present invention relates to a liquid ejecting apparatus such as an ink jet printer.

2. Related Art

In general, ink jet printers are widely known as a liquid ejecting apparatus that ejects liquid from a liquid ejecting head. An example of such ink jet printers is a so-called line head printer. The line head printer has a plurality of recording heads (liquid ejecting sections) that are arranged and fixed in a zigzag pattern along a width direction of a recording sheet to be transported. In printing, each nozzle of the recording heads ejects ink (liquid) to the recording sheet being transported.

In such ink jet printers, the recording heads are cleaned in a timely manner so as to prevent the occurrence of ink ejection failures such as nozzle clogging and missing dots. In the cleaning process of the recording head, a cap abuts the recording head so as to surround the nozzles of the recording head, thereafter air inside a hermetically closed space formed with the recording head and the cap is sucked to generate negative pressure in the hermetically closed space, and with the generated negative pressure, air bubbles are forcibly drained together with ink having high viscosity into the cap from each nozzle.

The line head printer normally has a structure in which ink is supplied from an ink cartridge (a liquid supplying source) to a plurality of recording heads through an ink supplying flow path (a liquid supplying flow path). The ink supplying flow path, thus, branches into a plurality of flow paths at a branch point located halfway along the ink supplying flow path, and each branched flow path is connected to one of the recording heads. Because of this structure, for example, a problem arises in that when one of the recording heads is selectively cleaned, ink in each nozzle of other recording heads that are not subjected to cleaning is sucked up and drained into the recording head being cleaned since the recording heads communicate with each other through the branch point in the ink supplying flow path.

In order to cope with this problem, a printer has been proposed in which a closing valve is provided between a branch point in a supplying flow path (a liquid supplying flow path) and each discharging head (a liquid ejecting head). For example, refer to JP-A-2009-6686, which is an example of the related art. The printer disclosed in JP-A-2009-6686 carries out cleaning by closing the closing valves corresponding to the discharging heads that are not being subjected to cleaning and opening the closing valves corresponding to the discharging heads that are being subjected to cleaning.

In addition, the line head printer has another problem in that when some recording heads are ejecting ink and other recording heads are not ejecting ink according to a fixed print pattern, ink in each nozzle of the recording heads that are not ejecting ink is sucked up and drained into the recording heads when ejecting ink in the same manner as when cleaning.

In order to cope with this problem, a printer has been proposed in which a flow path load section having a valve function is provided to each branch tube path of a supplying tube path (a liquid supplying flow path). For example, refer to JP-A-2005-306016, which is another example of the related art. The printer disclosed in JP-A-2005-306016 carries out printing by closing the flow path load sections of the branch tube paths corresponding to head blocks (liquid ejecting heads) that do not discharge ink when printing and opening the flow path load sections of the branch tube paths corresponding to the head blocks that discharge ink when printing.

The printers disclosed in JP-A-2009-6686 and JP-A-2005-306016, however, have the following problem. When ink is discharged from all of the recording heads and an ink discharging amount markedly differs among the recording heads, ink in a nozzle that does not discharge ink in the nozzles of a recording head that discharges a small amount of ink is sucked up and drained into another recording head that discharges a larger amount of ink. As a result, ink ejection failures occur when ink is ejected in subsequent printing from the nozzle from which ink has been drained.

### SUMMARY

An advantage of an aspect of the invention is that it provides a liquid ejecting apparatus that can preferably prevent an occurrence of liquid ejection failures.

A liquid ejecting apparatus according to an aspect of the invention includes a plurality of liquid ejecting sections ejecting liquid, a liquid supplying source, and a liquid supplying flow path that supplies each of the plurality of liquid ejecting sections with the liquid from the liquid supplying source. An upstream side of the liquid supplying flow path is coupled to the liquid supplying source while a downstream side of the liquid supplying flow path branches into a plurality of flow paths at a branch point, and each of the plurality of flow paths is coupled to one of the liquid ejecting sections. In the liquid supplying flow path, an average flow path resistance value of a flow path upstream of the branch point serving as a reference is smaller than an average flow path resistance value of a flow path having the smallest average flow path resistance value among average flow path resistance values of flow paths downstream of the branch point serving as the reference.

According to the aspect of the invention, liquid can be prevented from flowing back along each flow path in a downstream side from a branch point serving as a reference in the liquid supplying flow path even when liquid is ejected from any of the liquid ejecting sections. In other words, even when liquid is ejected from any of the liquid ejecting sections, a liquid flow between the flow paths in the downstream side through the branch point can be prevented, and liquid can reliably flow from the flow path in the upstream side to the flow paths corresponding to the liquid ejecting sections ejecting the liquid in the downstream side through the branch point. Because of this structure, liquid in a liquid ejecting section that is not ejecting liquid or in a liquid ejecting section whose liquid ejection amount is small compared with that of other liquid ejection sections, can be prevented from being sucked up toward the side of a liquid ejecting section that is ejecting liquid or the side of a liquid ejecting section whose liquid ejection amount is large compared with that of other liquid ejecting sections. As a result, the occurrence of ejection failures can be preferably prevented.

In the liquid ejecting apparatus, each of the average flow path resistance values may be determined when a flow rate of the liquid is maximum in the liquid supplying flow path. According to the aspect of the invention, each of the average flow path resistance values can be compared with certainty.

In the liquid ejecting apparatus, the liquid supplying flow path may include two or more branch points. According to the aspect of the invention, liquid in the liquid supplying source can be supplied to a large number of the liquid ejecting sections.

In the liquid ejecting apparatus, the numbers of flow paths that branch at the branch points in the liquid supplying flow path may be equal to each other. According to the aspect of the invention, liquid in the liquid supplying source can be supplied to a large number of the liquid ejecting sections in a balanced manner.

### BRIEF DESCRIPTION OF THE DRAWINGS

The invention will be described with reference to the accompanying drawings, wherein like numbers reference like elements.

FIG. 1 is a schematic view illustrating a rough structure of an ink jet printer according to an embodiment of the invention.

FIG. 2 is a schematic bottom view of a recording head unit of the ink jet printer.

FIG. 3 is a schematic view of an ink supplying flow path of the ink jet printer.

FIG. 4A is a schematic view of an ink supplying flow path when four recording heads are provided as a modified example.

FIG. 4B is a schematic view of an ink supplying flow path when two recording heads are provided in another modified example.

### DESCRIPTION OF EXEMPLARY EMBODIMENTS

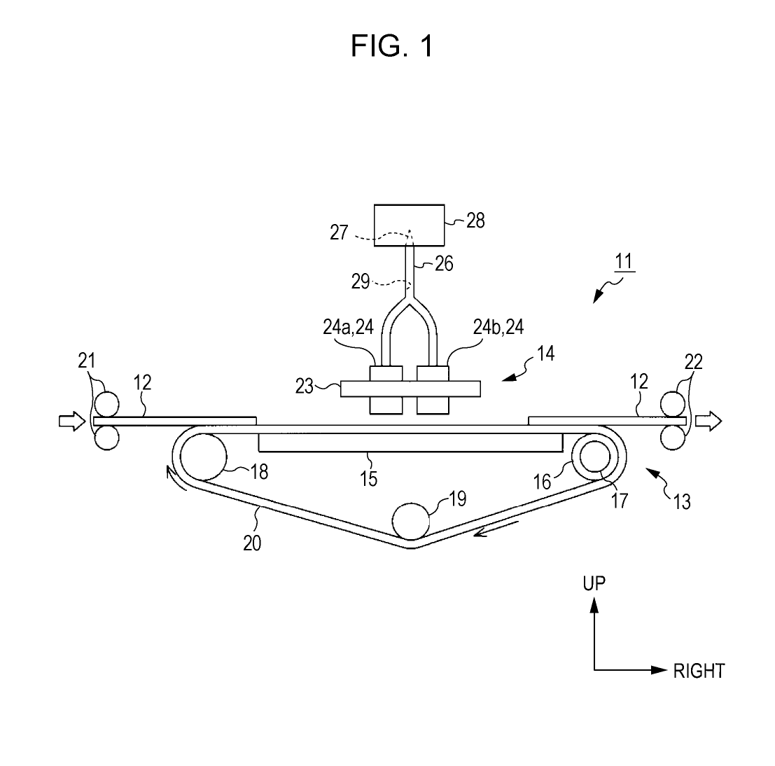

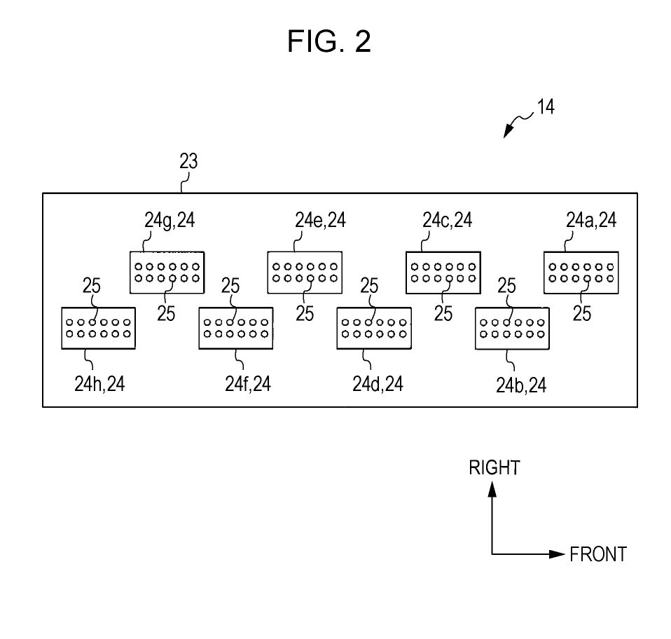

An embodiment in which a liquid ejecting apparatus of the invention is embodied in an ink jet printer is described below with reference to the accompanying drawings. In the following descriptions, a “front-back direction” means a direction indicated by the arrow labeled “FRONT”, a “left-right” direction means a direction indicated by the arrow labeled “RIGHT”, and an “up-down” direction means a direction indicated by the arrow labeled “UP” in FIG. 1 and FIG. 2.

As shown in FIG. 1, an ink jet printer 11 serving as the liquid ejecting apparatus is a so-called line head printer. The ink jet printer 11 includes in its main body frame (not shown) a transportation unit 13 that transports a recording sheet 12 that is sheet paper and a recording head unit 14 that is disposed and fixed above the transportation unit 13 so as to face the transportation unit 13.

The transportation unit 13 includes a platen 15 that has a rectangular plate shape longitudinally extending in the left-right direction and faces the recording head unit 14. A drive roller 16 is disposed on the right side of the platen 15 while a driven roller 18 is disposed on the left side of the platen 15. The drive roller 16 extends in the front-back direction and can be rotationally driven by a drive motor 17. The driven roller 18 extends in the front-back direction and can rotate. In addition, a tension roller 19 is disposed under the platen 15. The tension roller 19 extends in the front-back direction and can rotate.

An endless transportation belt 20 having a large number of through holes (not shown) is wound around the drive roller 16, the driven roller 18, and the tension roller 19 so as to surround the platen 15. In this case, the tension roller 19 is urged downward by a spring member (not shown). Because of this structure, the deflection of the transportation belt 20 is reduced with tension imparted by the tension roller 19.

When the drive roller 16 is rotationally driven clockwise as viewed from the front side, the transportation belt 20 is moved clockwise as viewed from the front side to go around the outside of the drive roller 16, the tension roller 19, and the driven roller 18. With the rotational movement of the transportation belt 20, an inner surface of the transportation belt 20 slides on an upper surface of the platen 15 from the left side toward the right side, whereby the recording sheet 12 on the transportation belt 20 is transported from the left side toward the right side. In this case, the recording sheet 12 existing at a position facing an upper surface of the platen 15 is sucked toward the platen 15 by a suction unit (not shown) provided onto the platen 15 with the transportation belt 20 interposed between the recording sheet 12 and the suction unit.

A pair of sheet feed rollers 21 are provided on the diagonally upper left side of the driven roller 18. The pair of sheet feed rollers 21 are disposed in the up-down direction and sequentially feed a plurality of recording sheets 12 onto the transportation belt 20 before printing is performed sheet by sheet. On the other hand, a pair of sheet discharge rollers 22 are provided on the diagonally upper right side of the drive roller 16. The pair of sheet discharge rollers 22 are disposed in the up-down direction and discharge the recording sheets 12 from an upper surface of the transportation belt 20 after printing has been performed sheet by sheet.

As shown in FIG. 1 and FIG. 2, the recording head unit 14 includes a supporting plate 23 having a rectangular plate shape and a plurality of recording heads 24 (eight heads in the embodiment) that are fixed to the supporting plate 23 and each of which serves as a liquid ejecting section. The recording heads 24 are arranged in a regular zigzag pattern along the front-back direction (a width direction of the recording sheet 12). The recording heads 24 are labeled as the recording heads 24a, 24b, 24c, 24d, 24e, 24f, 24g, and 24h in this order from the recording head disposed at the front most side.

The length from a front edge of the recording head 24a to a rear edge of the recording head 24h is somewhat longer than the width of the recording sheet 12 of a maximum size. The recording heads 24 adjacent to each other in the front-back direction are partially superposed in the left-right direction. In addition, a lower surface of each of the recording heads 24a to 24h has a plurality of nozzles 25 as openings. The plurality of nozzles 25 eject ink as liquid to the recording sheet 12 transported by the transportation unit 13. The nozzles 25 form two nozzle rows each of which is arranged along the front-back direction on the lower surface of each of the recording heads 24a to 24h. The two nozzle rows extend in parallel in the front-back direction so as to be adjacent to each other in the left-right direction.

Each of the recording heads 24a to 24h is connected to an ink cartridge 28 serving as a liquid supplying source through an ink supplying tube 26 and an ink supplying needle 27. In other words, an upstream side of the ink supplying tube 26 is connected to the ink cartridge 28 through the ink supplying needle 27 while a downstream side of the ink supplying tube 26 branches into a plurality of branches (two) at each of a plurality of (seven in the embodiment) branch points so that each of the branched tubes is connected to one of the recording heads 24a to 24h.

Accordingly, ink is supplied to each of the recording heads 24a to 24h from the ink cartridge 28 through the ink supplying needle 27 and the ink supplying tube 26. Ink supplied from the ink cartridge 28 is ejected from the nozzles 25 of the recording heads 24a to 24h to the recording sheet 12 transported by the transportation unit 13. Printing is carried out in this way.

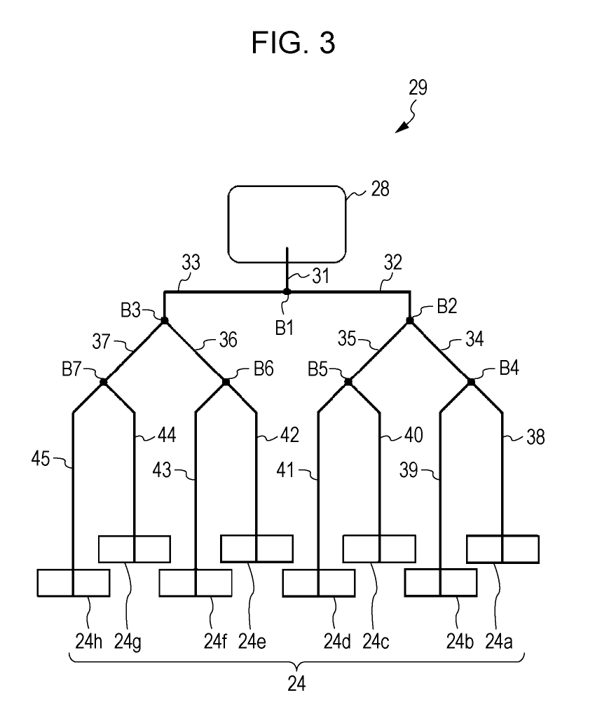

In the embodiment, an ink supplying flow path 29 (refer to FIG. 3) serving as a liquid supplying flow path is composed of a flow path in the ink supplying needle 27, a flow path in the ink supplying tube 26, and a flow path that allows a downstream end of the ink supplying tube 26 to communicate with each of the nozzles 25 in each of the recording heads 24a to 24h.

Next, a structure of the ink supplying flow path 29 is described in detail.

As shown in FIG. 3, a main flow path 31 extending from an upstream end located in the ink cartridge 28 toward a downstream side branches into branched flow paths 32 and 33 (two flow paths) at a branch point B1, in the ink supplying flow path 29. The branched flow path 32 branches into branched flow paths 34 and 35 (two flow paths) at a branch point B2 while the branched flow path 33 branches into branched flow paths 36 and 37 (two flow paths) at a branch point B3.

The branched flow path 34 branches into branched flow paths 38 and 39 (two flow paths) at a branch point B4 while the branched flow path 35 branches into branched flow paths 40 and 41 (two flow paths) at a branch point B5. Each downstream end of the branched flow paths 38 to 41 reaches the nozzles 25 of one of the recording heads 24a to 24d (refer to FIG. 2).

The branched flow path 36 branches into branched flow paths 42 and 43 (two flow paths) at a branch point BE while the branched flow path 37 branches into branched flow paths 44 and 45 (two flow paths) at a branch point B7. Each downstream end of the branched flow paths 42 to 45 reaches the nozzles 25 of one of the recording heads 24e to 24h (refer to FIG. 2). In this way, the ink supplying flow path 29 branches into two flow paths at each of the branch points B1 to B7, i.e., the branched flow paths 32 to 45 in total.

In the ink supplying flow path 29, in the case that each of the branch points B1 to B7 is considered as a reference, an average flow path resistance value of a flow path from a branch point (one of the branch points B1 to B7) to the upstream end is set to be smaller than the smallest average flow path resistance value of flow paths from the branch point to the downstream ends of the flow paths. In other words, in the ink supplying flow path 29, in the case that each of the branch points B1 to B7 is considered as a reference, an average flow path resistance value of a flow path from a branch point to the upstream end is set to be smaller than each of the average flow path resistance values of flow paths from the branch point to the downstream ends of the flow paths. In this case, the average flow path resistance value of each flow path is measured when ink flows in each flow path at a maximum flow rate, and set to a desired value by adjusting a diameter and/or a length of each flow path, for example.

Specifically, in the case that the branch point B1 is considered as a reference in the ink supplying flow path 29, an average flow path resistance value of the main flow path 31 is smaller than each of a sum of the average flow path resistance values of the branched flow paths 32, 34, and 38; a sum of the average flow path resistance values of the branched flow paths 32, 34, and 39; a sum of the average flow path resistance values of the branched flow paths 32, 35, and 40; a sum of the average flow path resistance values of the branched flow paths 32, 35, and 41; a sum of the average flow path resistance values of the branched flow paths 33, 36, and 42; a sum of the average flow path resistance values of the branched flow paths 33, 36, and 43; a sum of the average flow path resistance values of the branched flow paths 33, 37, and 44; and a sum of the average flow path resistance values of the branched flow paths 33, 37, and 45.

In the case that the branch point B2 is considered as a reference in the ink supplying flow path 29, a sum of the average flow path resistance values of the main flow path 31 and the branched flow path 32 is smaller than each of a sum of the average flow path resistance values of the branched flow paths 34 and 38; a sum of the average flow path resistance values of the branched flow paths 34 and 39; a sum of the average flow path resistance values of the branched flow paths 35 and 40; and a sum of the average flow path resistance values of the branched flow paths 35 and 41. In the case that the branch point B4 is considered as a reference in the ink supplying flow path 29, a sum of the average flow path resistance values of the main flow path 31, the branched flow path 32, and the branched flow path 34 is smaller than each of the average flow path resistance values of the branched flow paths 38 and 39.

Such a magnitude relationship between the average flow path resistance values of the flow paths in the ink supplying flow path 29 is the same in the case that each of the branch points B3, B5, B6, and B7 is considered as a reference and in the case that each of the branch points B1, B2, and B4 is considered as a reference as described above.

Next, an operation of the ink jet printer 11 is described.

When the recording sheet 12 is to be subjected to printing, first, the drive motor 17, the sheet feed rollers 21, and the sheet discharge rollers 22 are driven. Once they are driven, the recording sheet 12 is transported from the left side toward the right side along a transportation path. Then, ink is ejected from each of the nozzles 25 of each of the recording heads 24a to 24h toward the recording sheet 12 that is transported above the platen 15 while being supported by the transportation belt 20. As a result, a pre-set printing pattern is printed on the recording sheet 12. The recording sheet 12 after printing is thereafter discharged by the sheet discharge rollers 22 from the upper surface of the transportation belt 20.

If, in the ink supplying flow path 29, in the case that each of the branch points B1 to B7 is considered as a reference, an average flow path resistance value of a flow path from a branch point to the upstream end is larger than each of the average flow path resistance values of flow paths from the branch point to the downstream ends of the flow paths, the following problems arise.

For example, when a printing pattern is printed that is achieved by ejecting ink from all of the nozzles 25 of the recording head 24a and part of the nozzles 25 of the recording head 24b, an ink ejection amount of the recording head 24a is significantly larger than that of the recording head 24b.

In this case, in the case that the branch point B4 is considered as a reference, the sum of the average flow path resistance values of the main flow path 31, the branched flow path 32 and the branched flow path 34 is larger than each of the average flow path resistance values of the branched flow paths 38 and 39. As a result, ink in the branched flow path 39 flows back and flows along the branched flow path 38 through the branch point B4 with an ink flow from the branched flow path 34 to the branched flow path 38.

At this juncture, depending on conditions, ink in the branched flow path 35 may flow back and flow along the branched flow path 34 through the branch point B2 with an ink flow from the branched flow path 32 to the branched flow path 34, or ink in the branched flow path 33 may flow back and flow along the branched flow path 32 through the branch point B1 with an ink flow from the main flow path 31 to the branched flow path 32.

Because of the back-flow, air is sucked up particularly through the openings of a large number of the nozzles 25 that are not ejecting ink among the nozzles 25 of the recording head 24b. In other words, ink in a large number of the nozzles 25 that are specifically not ejecting ink among the nozzles 25 of the recording head 24b is sucked up into the recording head 24a through the branch point B4 and drained from the large number of the nozzles 25 at once. Hence, when a printing pattern, which is achieved by ejecting ink from the nozzles 25 of the recording head 24b from which ink has been drained, is printed in subsequent printing, a problem arises in that ink ejection failures such as missing dots occur.

In this regard, in the case that each of the branch points B1 to B7 is considered as a reference, in the embodiment, the average flow path resistance value of a flow path from a branch point to the upstream end is set to be smaller than the smallest average flow path resistance value of flow paths from the branch point to the downstream ends of the flow paths in the ink supplying flow path 29. Based on the setting, in the case that the branch point B4 is considered as a reference, the sum of the average flow path resistance values of the main flow path 31, the branched flow paths 32 and 34 is smaller than each of the average flow path resistance values of the branched flow paths 38 and 39.

Accordingly, even if an ink ejection amount from the recording head 24a is significantly larger than that from the recording head 24b as described above, ink in the branched flow path 39 can be prevented from flowing back and flowing along the branched flow path 38 through the branch point B4 with an ink flow from the branched flow path 34 to the branched flow path 38. This is because, ink flows more easily in a flow path having a low average flow path resistance value than in a flow path having a high average flow path resistance value.

Hence, ink in a large number of the nozzles 25 that specifically are not ejecting ink among the nozzles 25 of the recording head 24b can be prevented from being sucked up and drained into the recording head 24a through the branch point B4. Consequently, even if a printing pattern that is achieved by ejecting ink from all of the nozzles 25 of the recording head 24b is printed in subsequent printing, the occurrence of ink ejection failures such as missing dots can be prevented.

In the same manner as described above, ink can be prevented from flowing back in a downstream side defined by setting each of the branch points B1 to B7 as a reference in the ink supplying flow path 29 even when, in printing in which ink is ejected from all of the recording heads 24a to 24h, an ink ejection amount or the number of nozzles 25 ejecting ink significantly differs among the recording heads 24a to 24h. In other words, ink can be prevented from flowing back from a recording head 24 ejecting ink in a relatively small ejection amount to a recording head 24 ejecting ink in a relatively large ejection amount. Consequently, the occurrence of ink ejection failures such as missing dots can be prevented even if a printing pattern is printed in subsequent printing.

According to the embodiment described above in detail, the following effects can be obtained.

In the ink supplying flow path 29, in the case that each of the branch points B1 to B7 is considered as a reference, an average flow path resistance value of a flow path from a branch point to the upstream end is set to be smaller than the smallest average flow path resistance value of flow paths from the branch point to the downstream ends of the flow paths. Because of this setting, even when ink is ejected from any nozzle among the nozzles 25 of the recording heads 24a to 24h, ink can be prevented from flowing back in the branched flow paths 32 to 45 in a downstream side defined by setting each of the branch points B1 to B7 as a reference in the ink supplying flow path 29. In other words, even when ink is ejected from any nozzle among the nozzles 25 of the recording heads 24a to 24h, an ink flow between the branched flow paths 32 to 45 adjacent to each other in the downstream side through each of the branch points B1 to B7 in the ink supplying flow path 29 can be prevented, and ink can reliably flow from the flow path in the upstream side to the respective branched flow paths 32 to 45 corresponding to the recording heads 24 ejecting ink among the recording heads 24a to 24h in the downstream side through the respective branch points B1 to B7. Accordingly, ink in each of the nozzles 25 of one of the recording heads 24 that is ejecting no ink or whose ink ejection amount is small compared with that of other recording heads 24 can be prevented from being sucked up and drained into another of the recording heads 24 that is ejecting ink or whose ink ejection amount is large compared with that of other recording heads 24. As a result, the occurrence of ink ejection failures such as missing dots can be preferably prevented in subsequent printing.

The average flow path resistance values of the main flow path 31 and the branched flow paths 32 to 45 in the ink supplying flow path 29 are measured when ink flows in each of the flow paths 31 to 45 at a maximum flow rate. This makes it possible to compare, with certainty, the average flow path resistance values with each other among the flow paths 31 to 45.

Since a plurality of branch points, i.e., the seven branch points B1 to B7, is provided in the ink supplying flow path 29, ink stored in the ink cartridge 28 can be supplied to a large number of recording heads, i.e., the eight recording heads 24a to 24h.

The numbers of branched flow paths that branch at the branch points B1 to B7 in the ink supplying flow path 29 are equal to each other. In other words, a flow path branches into two (even number) branched flow paths in the same manner at each of the branch points B1 to B7 in the ink supplying flow path 29. As a result, ink stored in the ink cartridge 28 can be supplied to a large number of recording heads, i.e., the eight recording heads 24a to 24h in a balanced manner.

### Modified Examples

The above-described embodiment may be modified as follows.

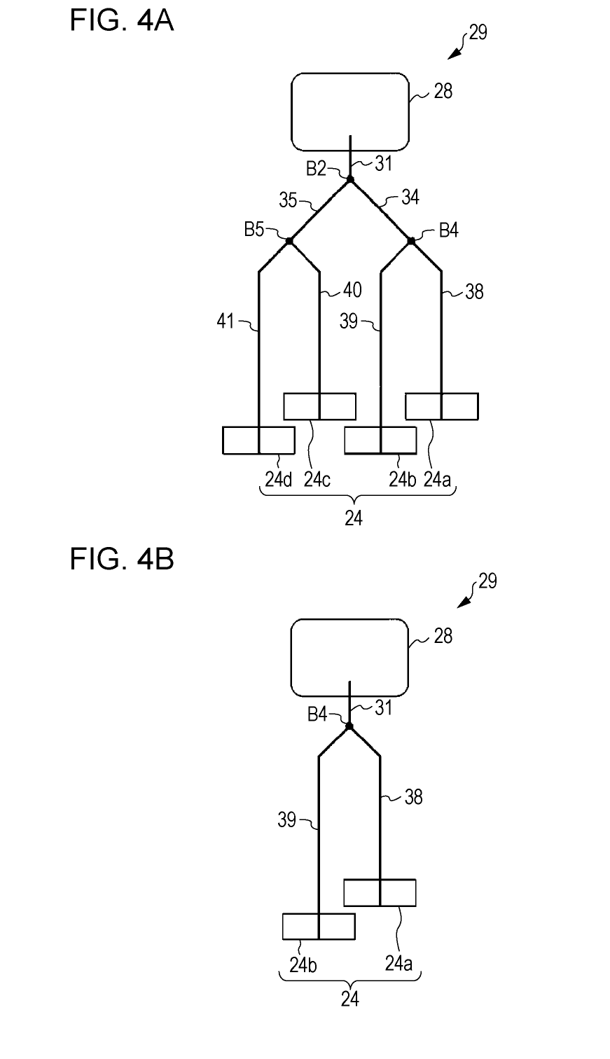

As shown in FIG. 4A, the downstream end of the main flow path 31 may be connected to the branch point B2 in the ink supplying flow path 29 so as to provide the four recording heads 24.

As shown in FIG. 4B, the downstream end of the main flow path 31 may be connected to the branch point B4 in the ink supplying flow path 29 so as to provide the two recording heads 24. In other words, only one branch point may be provided in the ink supplying flow path 29.

The ink supplying flow path 29 may be structured in such a manner that a flow path branches into three or more branched flow paths at each of the branch points B1 to B7. In other words, the numbers of branched flow paths at the branch points B1 to B7 in the ink supplying flow path 29 may be odd numbers of three or more or even numbers of four or more.

The numbers of branched flow paths at the branch points B1 to B7 in the ink supplying flow path 29 may not necessarily be equal to each other.

The average flow path resistance values of the main flow path 31 and the branched flow paths 32 to 45 in the ink supplying flow path 29 may not necessarily be measured when ink flows in each of the flow paths 31 to 45 at a maximum flow rate.

As a substitute for the ink cartridge 28, a sub-tank temporarily storing ink supplied from the ink cartridge 28 may be used as the liquid supplying source.

The nozzle row composed of the nozzles 25 of the recording head 24 may serve as the liquid ejecting section. In this case, ink in the ink cartridge 28 is supplied on a nozzle row basis through each branched flow path in the ink supplying flow path 29.

The recording sheet 12 may be roll paper (continuous paper). In this case, the transportation belt 20 is omitted.

The ink jet printer 11 may handle, for example, a plastic film as an ink ejection object in addition to the recording sheet 12.

The ink jet printer 11 may be a serial head printer that ejects ink to the recording sheet 12 in a held state while moving its recording head in a horizontal direction.

While the liquid ejecting apparatus is embodied as the ink jet printer 11 in the embodiment, other liquid ejecting apparatuses that eject or discharge other liquid besides ink may be adopted. The embodiment can be applied to various kinds of liquid ejecting apparatuses including liquid ejecting heads ejecting a very small amount of liquid. Here, the term “droplets” means forms of liquid discharged from the above-described liquid ejecting apparatuses, which include forms such as a granular form, a tear-like form, and a string-like form. In addition, liquid described herein may include materials that can be ejected by the liquid ejecting apparatuses. Materials including substances in a state such as a liquid phase may be used. Examples of such a state include a fluid state such as a liquid body having high or low viscosity, sol water, gel water, inorganic solvents, organic solvents, solutions, liquid resins, and liquid metals (metal melt). In addition to liquid as one state of a substance, a state is also included in which solid functional material particles such as pigments and metal particles are dissolved, dispersed, or mixed in a solvent. Typical examples of liquid include ink described in the embodiment and liquid crystal. Here, ink includes common water-based ink, common oil-based ink, and various kinds of liquid composition such as gel ink and hot melt ink. Specific examples of the liquid ejecting apparatus may include: liquid ejecting apparatuses ejecting liquid in which electrode materials or color materials that are used for manufacturing liquid crystal displays, electroluminescence (EL) displays, surface-emitting displays and color filters are dispersed or dissolved; liquid ejecting apparatuses ejecting biological organic substances used for manufacturing biochips; liquid ejecting apparatuses ejecting liquid that serves as a specimen used for a precision pipette; printing apparatuses; and micro-dispensers. The examples may further include: liquid ejecting apparatuses ejecting lubricant oil with pinpoint precision to precision instruments such as watches and cameras; liquid ejecting apparatuses ejecting, on substrates, transparent resin liquid such as ultraviolet curable resins so as to form, for example, hemispherical micro-lenses used for, for example, optical communication elements; and liquid ejecting apparatuses ejecting etching solutions such as acid or alkali so as to etch substrates, for example. The liquid ejecting apparatus according to the embodiment of the invention can be applied to any one of the above-described examples.

In addition, a technical idea grasped from the embodiment is described below.

In a liquid ejecting apparatus, the number of flow paths that branch at the branch point in the liquid supplying flow path is an odd number.

According to the liquid ejecting apparatus, liquid in the liquid supplying source can be supplied to a large number of the liquid ejecting sections in a further balanced manner.

The disclosure of Japanese Patent Application No. 2010-029846, filed Feb. 15, 2010, is expressly incorporated by reference herein.

What is claimed is:

1. A liquid ejecting apparatus, comprising:
a plurality of liquid ejecting sections ejecting liquid; and
a liquid supplying flow path that supplies each of the plurality of liquid ejecting sections with the liquid from a liquid supplying source,
wherein an upstream side of the liquid supplying flow path is coupled to the liquid supplying source while a downstream side of the liquid supplying flow path branches into a plurality of flow paths at a branch point and each of the plurality of flow paths is coupled to one of the liquid ejecting sections, and
wherein, in the liquid supplying flow path, an average flow path resistance value of a flow path upstream of the branch point serving as a reference is smaller than an average flow path resistance value of a flow path having the smallest average flow path resistance value among average flow path resistance values of flow paths downstream of the branch point serving as the reference.

2. The liquid ejecting apparatus according to claim 1, wherein each of the average flow path resistance values is determined when a flow rate of the liquid is maximum in the liquid supplying flow path.

3. The liquid ejecting apparatus according to claim 1, wherein the liquid supplying flow path includes two or more branch points.

4. The liquid ejecting apparatus according to claim 3, wherein the numbers of flow paths that branch at the branch points in the liquid supplying flow path are equal to each other.
